(19) United States
(12) Patent Application Publication
(10) Pub. No.: US 2007/0159331 A1
(43) Pub. Date: Jul. 12, 2007

(54) System and method for saving battery power prior to deploying an asset tag

(75) Inventor: Chris Zegelin, San Jose, CA (US)

Correspondence Address: BAKER BOTTS L.L.P., 30 ROCKEFELLER PLAZA, 44TH FLOOR, NEW YORK, NY, 10112-4498, US

(73) Assignee: Symbol Technologies, Inc.

(21) Appl. No.: 11/324,677

(22) Filed: Jan. 3, 2006

(51) Int. Cl. G08B 13/14; H04Q 5/22

(52) U.S. Cl. 340/572.1; 340/539.3; 340/10.33; 340/10.1

(57) ABSTRACT

A system and method for locating assets within an area, each asset having a wireless circuit configured for low power consumption, the method comprising. The method including the steps of providing power to an RFID tag portion of the wireless circuit, and supplying power to a high power portion of the wireless circuit after a triggering event, for example: the purchase of the asset. The high power portion of the wireless circuit is prevented from accessing power from the battery prior to the triggering event.

### BACKGROUND OF THE INVENTION

The present invention relates to power conservation of radio frequency identification (RFID) technology used for identifying items or assets.

RFID technology exploits electromagnetic or electrostatic coupling in the radio frequency (RF) portion of the electromagnetic spectrum to uniquely identify and locate an item or asset. A conventional RFID system includes three primary components: an antenna and transceiver (often combined into one reader unit), and electronic devices called transponders or tags (the RFID tags) that are attached to the items or assets. The reader unit emits radio waves, and when an RFID tag is within the range of the reader unit, the tag responds and starts sending data.

RFID tags come in a wide variety of size, shapes and forms but have common attributes; each includes low-energy broadcast circuitry, programmable data storage and operating circuitry. Tags come with and without batteries, they can be read only or read/write. Typically, tags without batteries (passive tags) are smaller and lighter than those that are with batteries (active tags), and less expensive.

Reader electronics or units can be bare boards, electronic modules or fully enclosed boxes. The reader units can be fixed or handheld, similar to barcode scanners. Reader units are linked to other software systems that are used to aggregate and integrate the data. The reader unit may be may be linked over a wired or wireless network to a host processor/database for data processing. In some cases the reader units power, engage, download and retransmit data to the tag they encounter.

Low-frequency RFID systems (30 KHz to 500 KHz) have short transmission ranges (generally less than six feet). High-frequency RFID systems (850 MHz to 950 MHz and 2.4 GHz to 2.5 GHz) offer longer transmission ranges (e.g., about 90 feet).

RFID systems are now being proposed for wide spread use in business, e.g., in retail stores, as an alternative to the Universal Product Code (UPC) “bar code” technology. RFID tags are viewed as a superior replacement for UPC bar codes. For example, the data storage capacity in an RFID tag is sufficiently large so that each RFID tag may be assigned a unique code, while UPC codes are limited to a single code for all instances of a particular product. The uniqueness of RFID tags means that each tagged product potentially can be identified individually as it moves from location to location.

RFID systems also are now available for applications such as warehouse management, manufacturing workflow or material management. In these systems, low-cost passive RFID tags are attached to objects such as pallets. RFID tag readers, which generally have a short range generally of about six to ten feet, are deployed to read the RFID tags. RFID tag readers (“portals”) are placed at fixed strategic locations such as dock entrances or doorways to monitor or read RFID-tagged pallets as they pass through. Each RFID reader portal may be wired to an Ethernet network or other standard data communication networks (wired or wireless), so that RFID tag data captured by the RFID reader portal can be transferred through standard interfaces to a host computer, printer or programmable logic controller for storage or action. Such RFID systems can readily provide information on whether a tagged pallet is in or out of a building or on or off the dock, by associating the location of the tagged pallet with the position of the last fixed reader portal it passed through. However, present day RFID systems are not cost effective for locating assets more precisely, for example, in large warehouse or buildings, or for locating high-value assets to within a few feet. The space requirements and the cost of deploying a sufficient number of RFID reader portals in a warehouse to locate precisely where a tagged palette is all times can be prohibitive.

Unlike RFID systems that provide the last known location of an asset based on the position of the last RFID reader portal to scan the asset, alternative wireless systems that can locate assets more precisely have been developed (e.g., Real Time Locating Systems (RTLS)). RTLS consists of readers or antennas to pick up RF signals from active battery-powered RFID tags attached to assets. The readers and antennas are deployed in strategic locations much as conventional access points in wireless data communication network systems are deployed. However, RTLS also has the same cost disadvantages of fixed RFID reader portal systems at least because it involves the use of expensive battery-powered active RFID tags. RTLS systems may be commercially viable for locating high value assets, but less so in high volume, low cost applications such as retail or commodity warehouse or yard management applications.

Active RFID tags have a problem whereby RFID tags fail due to battery drain after a period of time. Items without RFID functionality are turned off until they are sold, thus the battery drain is exceedingly minimal. However, active RFID tags use battery power to transmit identification information in order to facilitate identification of the item. Active RFID tags transmit identification further than passive RFID tags, which allow the installation of fewer RFID readers in a given location. Active RFID tags are generally bundled with other circuitry in an item, frequently with other wireless components of the item. When RFID circuitry is bundled with other wireless circuitry, the battery drain is exacerbated. High power wireless circuitry, for example Bluetooth compatible wireless circuitry, drains the charge in a battery quickly. The drain of charge in a battery eventually causes the RFID tags to fail. With products that are on a shelf or in a supply chain for a significant period of time this becomes a significant problem.

Consideration is now being given to ways of enhancing RFID systems and methods allowing RFID tags to operate for longer periods of time before failure due to battery failure.

### BRIEF SUMMARY OF THE INVENTION

In an embodiment of the invention, a method for locating assets within an area, each asset having a wireless circuit configured for low power consumption, is provided. The method includes the steps of providing power to an RFID tag portion of the wireless circuit, and supplying power to a high power portion of the wireless circuit after a triggering event.

### BRIEF DESCRIPTION OF THE DRAWINGS

Further features of the invention, its nature, and various advantages will be more apparent from the following detailed description and the accompanying drawings, wherein like reference characters represent like elements throughout, and in which:

FIG. 1 is a schematic block diagram of a mobile RFID portal, which includes RFID reader electronics and a radio for data communication with a wireless network, in accordance with the principles of the present invention;

FIG. 2 is a schematic representation of the mobile RFID portal of FIG. 1 configured as a motorized vehicle, which is deployed on a warehouse floor to read RFID tags on assets that are located on shelves along aisles in the warehouse, in accordance with the principles of the present invention.

Throughout the figures, unless otherwise stated, the same reference numerals and characters are used to denote like features, elements, components, or portions of the illustrated embodiments.

### DETAILED DESCRIPTION OF THE INVENTION

In accordance with the invention, an RFID-tagged asset is provided including a wireless transmitter/receiver portion. The wireless portion includes an RFID tag. Multiple RFID-tagged assets may be provided in an area of interest. The wireless portion is powered by a local power source. The RFID tag is selectively powered by the local power source separately from the remainder of the wireless portion. Selectively powering the RFID tag conserves the power of the local power source.

For convenience in the description herein, a warehouse building (building 200 FIG. 2) is used as the exemplary area of interest. It will, however, be understood that the area of interest may be any area in which of assets are stored, moved or used (e.g. a transportation yard, retail store, a manufacturing plant, or other buildings or spaces). Warehouse building 200 may be serviced in a conventional manner by wireless and/or wired networks for data communications that, for example, are commonly used in present day business operations. FIG. 2 shows, for example, wireless access points 240 of a wireless data communications network 210, which is installed in building 200. FIG. 2 also shows, for example, Ethernet or cable switch 220 of a wired data communication network 240, which also may be installed in warehouse building 200 in addition to wireless data communications network 210.

Each mobile RFID portal 100 in the configuration has at least one antenna/transceiver (“reader unit”) for reading RFID tags that are attached to assets. The reader unit may be any conventional low-power, low-cost unit. The reader unit antenna may have an effective range “R” for reading RFID tags such that when stationary, the reader unit can effectively read RFID tags on assets that are located within a zone or area A (˜R2). The effective range R may be selected to be suitably short (e.g., about a few feet) to provide greater precision in the location of assets. Each mobile RFID portal also may be provided with a radio or other means by which it can communicate with a wireless or wired network that may be deployed for data communications in warehouse building 200.

Mobile RFID portal 100 may be disposed on a motorized robot or vehicle 290, which can be moved, for example, on the floor of warehouse building 200 in aisles between shelves on which RFID tagged assets are placed. Vehicle 290 may be a vehicle that is specifically designated for moving mobile RFID portal 100, or may be a vehicle which has other primary use in the warehouse operation (e.g., a forklift). The movement of vehicle 290 may be computer and/or remotely controlled using conventional control mechanisms (not shown). Mobile RFID portal 100 or the vehicle 290 may be provided with an optional docking interface 50 that can be coupled to a mating interface 50′, for example, at a vehicle docking station 230. Docking station 230 and interfaces 50/50′ may be conventionally configured to provide utilities to a docked RFID portal 100/vehicle 290. The utilities may, for example, include Ethernet connection (240) and/or power for recharging battery.

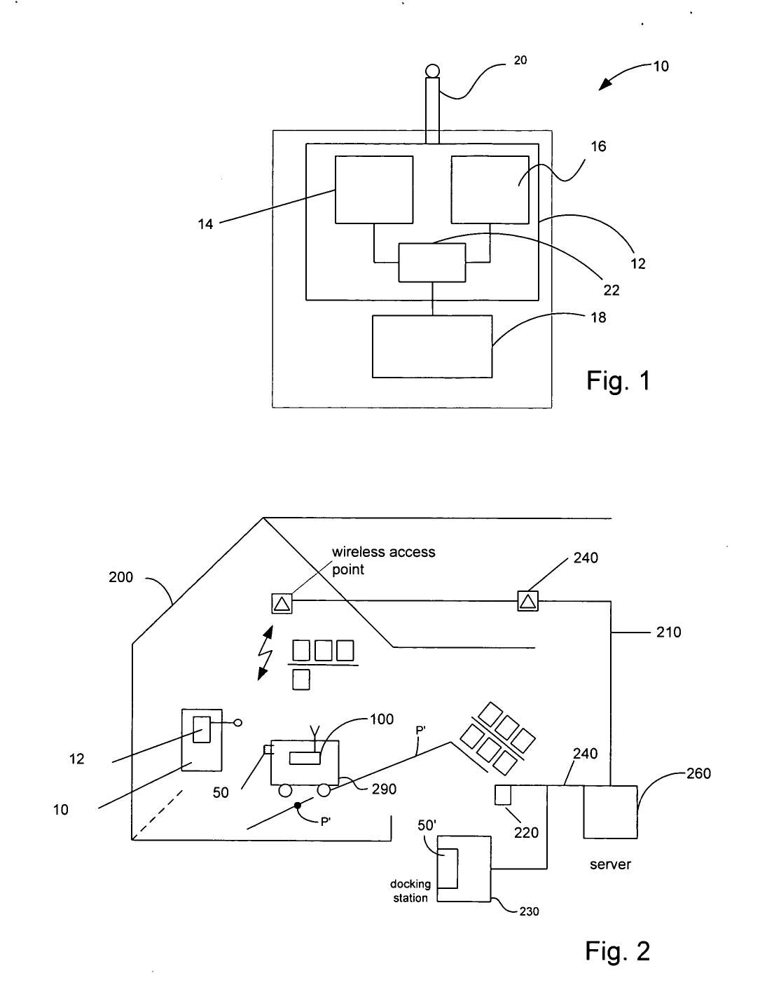

FIG. 1 shows a block diagram of an exemplary RFID-tagged asset 10 that may be used in conjunction with the present invention to identify RFID-tagged assets in a warehouse building 200. The RFID-tagged asset 10 is provided including a wireless transmitter/receiver portion 12. The wireless portion 12 includes an RFID tag 14. The RFID tag 14 has a limited effective range. Multiple RFID-tagged assets 10 may be provided in an area of interest. The wireless portion 12 is powered by a local power source 18. The RFID tag 14 may be selectively powered by the local power source 18 separately from the remainder of the wireless portion 12. Selectively powering the RFID tag 14 conserves the power of the local power source 18. In a certain embodiment, the local power source 18 is a battery or a rechargeable battery included within the RFID-tagged asset.

The wireless portion 12 may also include a high power transmitter/receiver 16. The high power transmitter receiver 16 may communicate using a particular type of wireless network over a large effective range. The high power transmitter/receiver 16 may be selectively powered by the local power source 18.

The wireless portion 12 is powered by the local power source 18 through a reed switch 22. The reed switch 22 is configured to selectively disable the high power transmitter/receiver 16. If the RFID-tagged asset 10 is configured in a low power consumption mode, the reed switch 22 provides power to the RFID tag 14, but disables the high power transmitter/receiver 16. On the other hand, if the RFID-tagged asset 10 is configured in a high power consumption mode, the reed switch 22 provides power to the RFID tag 14 and the high power transmitter/receiver 16. The reed switch 22 can work in parallel to the RFID link enabling/disabling the high power transmitter/receiver 16. One of ordinary skill in the art would understand that the reed switch within the circuit to disable/enable power to the high power wireless circuit may be employed in several different configurations within the scope of the present invention.

In a certain embodiment, the wireless portion 12 is a microprocessor. In another certain embodiment, the wireless portion 12 is incorporated into a microprocessor, an application specific integrated circuit (“ASIC”) or another programmable logic device.

In a certain embodiment, the reed switch 22 is a hall effect sensor when the reed switch 22 is connected to a microprocessor input. In another certain embodiment, the reed switch 22 provides power to the RFID tag and selectively to circuitry other than the high power transmitter/receiver 16.

The RFID tag 14 is an optional one-way or two-way RF radio, which is equipped with an antenna 20 for sending and/or receiving data over a wireless network. RF radio may be configured to communicate with the particular type of wireless data communications network 210 (e.g., an IEEE 802.11 or Bluetooth network or any other Wireless LAN or Wireless WAN) deployed in the warehouse 200. Depending upon the particular type of the wireless network, the RF radio may be a GPRS radio, 802.11b radio, Bluetooth radio, or any other device capable of transmitting and/or receiving data over the particular type of the wireless network.

In various different embodiments of the present invention, the conditions for enabling the high power wireless circuit may be established depending on the needs of the particular application. One of ordinary skill in the art would understand that the scope of the present invention is not restricted to any particular enabling conditions or application of the present invention. For example, in one embodiment, the high powered wireless circuit may be enabled upon sale of the asset, upon transfer of the asset from one location to another, etc.

It will be understood that the foregoing is only illustrative of the principles of the invention, and that various modifications can be made by those skilled in the art without departing from the scope and spirit of the invention. For example, a switch, other than the reed switch, may be used to supply power selectively to the RFID tag and the high power transmitter/receiver.

I claim:

1. A method for locating assets within an area, each asset having a wireless circuit configured for low power consumption, the method comprising:
providing power to an RFID tag portion of the wireless circuit; and
supplying power to a high power portion of the wireless circuit after a triggering event.

2. The method of claim 1 wherein the triggering event is the purchase of the asset.

3. The method of claim 1 wherein the high power portion of the wireless circuit is prevented from accessing power prior to the triggering event.

4. The method of claim 1 wherein the wireless circuit is provided with power from at least one of a battery and a rechargeable battery.

5. The method of claim 1 wherein a reed switch is configured to selectively disable the high power portion of the wireless circuit.

6. The method of claim 5, wherein the reed switch is a hall effect sensor.

7. The method of claim 1, wherein the wireless circuit is incorporated into one of a microprocessor, an application specific integrated circuit and a programmable logic device.

8. A system for locating an asset within an area, the system comprising:
wireless circuit configured for low power consumption, the wireless circuit including a powered RFID tag portion and a high power portion, wherein the high power portion is provided with power after a triggering event.

9. The system of claim 8 wherein the triggering event is the purchase of the asset.

10. The system of claim 8 wherein the high power portion of the wireless circuit is prevented from accessing power prior to the triggering event.

11. The system of claim 8 wherein the wireless circuit is provided with power from at least one of a battery and a rechargeable battery.

12. The system of claim 8 further comprising a reed switch, which is operatively connected to the RFID tag portion and the high power portion of the wireless circuit and is configured to selectively disable the high power portion of the wireless circuit.

13. The system of claim 12, wherein the reed switch is a hall effect sensor.

14. The system of claim 8, wherein the wireless circuit is incorporated into one of a microprocessor, an application specific integrated circuit and a programmable logic device.
